(19) United States
(12) Patent Application Publication
(10) Pub. No.: US 2011/0263187 A1
(43) Pub. Date: Oct. 27, 2011

(54) WIRE SAW AND METHOD FOR FABRICATING THE SAME

(76) Inventors: Yen-Kang Liu, Zhubei City (TW); Yi-Tsang Lee, Zhubei City (TW); Chien-Wei Kao, Zhubei City (TW)

(21) Appl. No.: 13/080,129

(22) Filed: Apr. 5, 2011

(30) Foreign Application Priority Data
Apr. 27, 2010 (TW) 099113262

(51) Int. Cl. B23D 61/18; B24D 3/00; B24D 11/00

(52) U.S. Cl. 451/528; 51/295

(57) ABSTRACT

The present invention relates to a wire saw and a method for fabricating the same. The method for fabricating a wire saw according to the present invention includes: providing a core wire; coating an intermediate layer over the core wire, and embedding a plurality of abrasives in the intermediate layer; and plating a metal protective layer over the abrasives. Accordingly, the present invention can resolve the conventional problem of abrasives in the plating bath aggregating during electroplating deposition, so as to enhance cutting quality and precision.

### CROSS REFERENCE TO RELATED APPLICATION

This application claims the benefits of the Taiwan Patent Application Serial Number 099113262, filed on Apr. 27, 2010, the subject matter of which is incorporated herein by reference.

### BACKGROUND OF THE INVENTION

1. Field of the Invention

The present invention relates to a wire saw and a method for fabricating the same, more particularly, to wire saw advantageous to the enhancement of cutting quality and having an extended lifetime and a method for fabricating the same.

2. Description of Related Art

Wire-saw cutting is a processing method for cutting semiconductors, crystals, various single crystals, magnetic materials, ceramic materials and other hard-brittle materials. Wire saws with free abrasives have been widely applied in a process for cutting semiconductor wafers, which use steel wire and free abrasives dispersed in a liquid to remove materials. However, the free abrasive wire saw slicing process has drawbacks of environmental pollution and waste of abrasives and low processing efficiency. Thereby, fixed abrasive wire saws have been developed and used popularly. Compared to free abrasive wire saws, fixed abrasive wire saws have numerous advantages, such as increased material removal rate, sufficient utilization of abrasives and enhanced throughput.

US 2009/0120422 A1 disclosed a fixed abrasive wire saw as shown in FIG. 1A, which is manufactured by dispersing abrasives 12 covered with a metal layer 121 into a plating bath and then simultaneously depositing the abrasives 12 and a plating layer 13 on the surface of a core wire 11. However, the aggregation of abrasives easily occurs in the plating process, and thereby it is necessary to control the dispersion and concentration of the abrasives in the plating bath to prevent the cutting quality and precision from being degraded by the aggregation of abrasives. JP 2007203393, JP 2007268627, JP 2007307669 and KR 20090026490 also disclosed a fixed abrasive wire saw manufactured by simultaneously depositing abrasives and a plating layer on a core wire. Thereby, the cutting quality and precision of wire saws manufactured by the processes described in those patent documents also may be degraded due to the aggregation of abrasives. Moreover, regarding the wire saws disclosed by JP 2007203393 and JP 2007268627, the abrasives are exposed and thereby may be separated from the core wire during the slicing process, resulting in the reduction of cutting efficiency and tool lifetime.

U.S. Pat. No. 6,463,921 suggested another fixed abrasive wire saw, as shown in FIG. 1B, which includes: a core wire 11; a plurality of abrasives 12 attached to the core wire 11; a photocurable resin layer 14, containing plural fillers 15 and formed on the core wire 11 to attach the abrasives 12 to the core wire 11; and a base layer 16, disposed between the core wire 11 and the photocurable resin layer 14 to enhance the adhesion between the core wire 11 and the photocurable resin layer 14. As shown in FIG. 1B, the abrasives 12 are fixed on the core wire 11 through the photocurable resin layer 14. However, the photocurable resin layer 14 cannot provide sufficient strength to firmly hold the abrasives 12, and the abrasives 12 are partially exposed. Thereby, the abrasives 12 may be separated from the core wire during the slicing process, resulting in the reduction of cutting efficiency.

### SUMMARY OF THE INVENTION

In view of conventional drawbacks, the object of the present invention is to provide a wire saw advantageous to the enhancement of the cutting quality and having an extended lifetime and a method for fabricating the same. To achieve the object, the present invention provides a method for fabricating a wire saw, including: (A) providing a core wire; (B) coating an intermediate layer over the core wire, and embedding a plurality of abrasives in the intermediate layer; and (C) plating a metal protective layer over the abrasives. Herein, the material of the intermediate layer may be an adhesive material, a solvent, a solution or a combination thereof. The adhesive material can be any material with adhesive property, and includes, for example, resin. The solvent may be any liquid solvent and its examples include water, oil, ethanol, acetone, methanol or a combination thereof. The solution may be any liquid solution, and includes, for example, a plating solution.

According to the present invention, the abrasives are first embedded in the intermediate layer; then the liquid intermediate layer can be attached on the core wire through capillary effect of the liquid intermediate layer (such as a water layer, an oil layer, an ethanol layer, an acetone layer, a methanol layer or plating solution layer), while the abrasives can be temporarily attached on the intermediate layer through van der Wall force and cohesion force of the intermediate layer or an adhesive intermediate layer (e.g. a resin layer); and finally a metal protective layer is formed to cover the abrasives. Compared to the conventional art of simultaneously depositing the abrasives and the plating metal layer, it is unnecessary for the present invention to control the dispersion and concentration of the abrasives in the plating bath, and the aggregation of the abrasives in the plating bath during the plating process can be inhibited. Thereby, the present invention can fabricate a wire saw with a better surface flatness and thus enhance cutting quality and precision. In addition, compared to the conventional art of holding abrasives through a photocurable resin layer, the present invention uses a metal protective layer to cover and firmly hold the abrasives, and thus can inhibit the departing of the abrasives during the cutting process, resulting in the extension of the wire saw lifetime and enhancement of the processing efficiency. Also, the metal protective layer over the abrasives can provide buffer and protection effects, resulting in the enhancement of cutting quality.

According to the method of the present invention, the step (B) may be performed by coating the intermediate layer over the core wire and then embedding the abrasives in the intermediate layer, or mixing component(s) of the intermediate layer with the abrasives to form a mixture and then coating the mixture over the core wire to thus form the intermediate layer over the core wire and embed the abrasives in the intermediate layer.

According to the above-mentioned method, in the case of using an adhesive material, a solvent, a solution or a combination as the intermediate layer and the intermediate layer being maintained over the core wire during the process for forming the metal protective layer, the fabricated wire saw includes: a core wire; an intermediate layer, disposed over the core wire and made of an adhesive material, a solvent, a solution or a combination thereof; a plurality of abrasives, embedded in the intermediate layer; and a metal protective layer, covering the abrasives and the intermediate layer. For example, when an adhesive material (e.g. resin), a nonvolatile liquid solvent (e.g. water, oil or a combination thereof), a nonvolatile liquid solution (e.g. a plating solution) or a combination thereof is used as the intermediate layer, the intermediate layer would be included in the fabricated wire saw due to that the intermediate layer is maintained over the core wire during the formation of the metal protective layer. On the other hand, if the intermediate layer gradually evaporates during the formation of the metal protective layer, another wire saw would be obtained, which includes: a core wire; a plurality of abrasives, dispersed over the core wire; and a metal protective layer, covering the abrasives and the core wire. For example, when a volatile liquid solvent (e.g. ethanol, acetone, methanol or a combination thereof) is used as the intermediate layer, the intermediate layer gradually evaporates during the formation of the metal protective layer, and the abrasives can be adsorbed on the core wire through van der Wall force, resulting in the formation of the wire saw including no intermediate layer.

In the present invention, the core wire may be a metal wire, such as a piano wire, a copper-coated piano wire, a twisted wire and a stainless steel wire. Preferably, the core wire is a copper-coated piano wire, such that the adhesion between the intermediate layer and the core wire can be enhanced through the copper layer coated on the piano wire.

In the present invention, the abrasives preferably have high hardness, such as diamond, cubic boron nitride, aluminum oxide and silicon carbide.

In the present invention, the surface of abrasives may be covered with a conductive layer. Herein, the conductive layer may be made of titanium, nickel, copper, silver, aluminum or a combination thereof.

In the present invention, the metal protective layer may be in a single-layered or multilayered structure, and can be made of nickel, copper, zinc, tin, silver or a combination thereof. Herein, the metal protective layer may be formed by an electroplating process, a chemical plating process (i.e. electroless plating) or a combination of the above-mentioned processes. That is, the metal protective layer may be an electroplating layer or a chemical plating layer; or the metal protective layer may include a chemical plating layer and an electroplating layer, therewith the chemical plating layer being located between the electroplating layer and the abrasives and between the electroplating layer and the intermediate layer.

### BRIEF DESCRIPTION OF THE DRAWINGS

FIG. 1A shows a longitudinal-sectional view of a conventional fixed abrasive wire saw;

FIG. 1B is shows a cross-sectional view of another conventional fixed abrasive wire saw;

FIGS. 2A to 2C show a process for fabricating a wire saw according to one preferred example of the present invention;

FIG. 3 shows a longitudinal-sectional view of a wire saw according to another preferred example of the present invention;

FIG. 4 shows a longitudinal-sectional view of a wire saw according to yet another preferred example of the present invention; and

FIG. 5 shows a longitudinal-sectional view of a wire saw according to further another preferred example of the present invention.

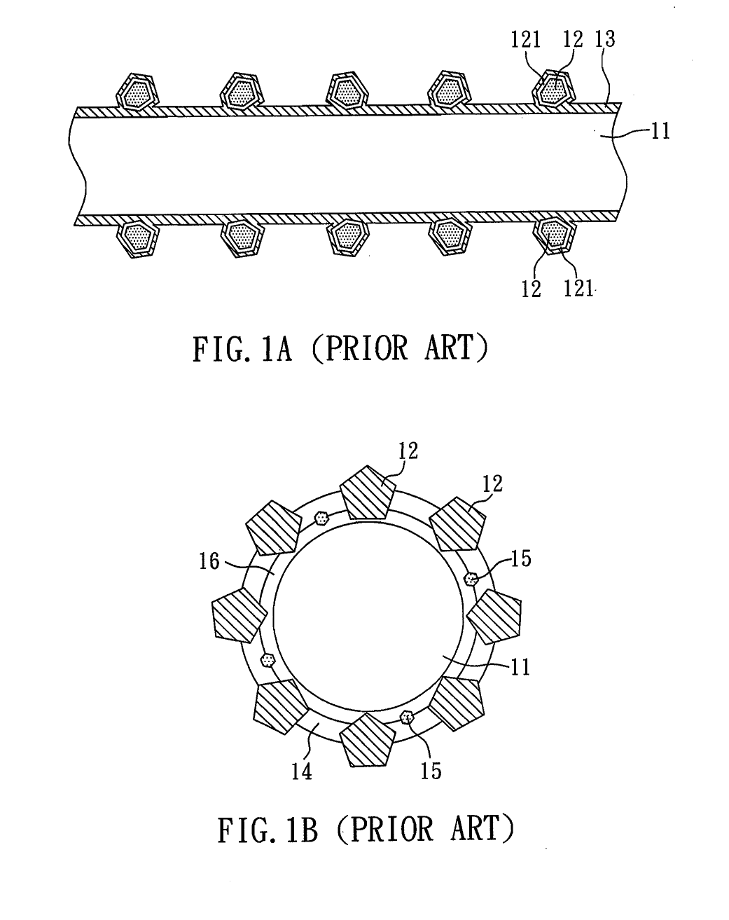

### DETAILED DESCRIPTION OF THE PREFERRED EMBODIMENT

Hereafter, examples will be provided to illustrate the embodiments of the present invention. Other advantages and effects of the invention will become more apparent from the disclosure of the present invention. Other various aspects also may be practiced or applied in the invention, and various modifications and variations can be made without departing from the spirit of the invention based on various concepts and applications.

### Example 1

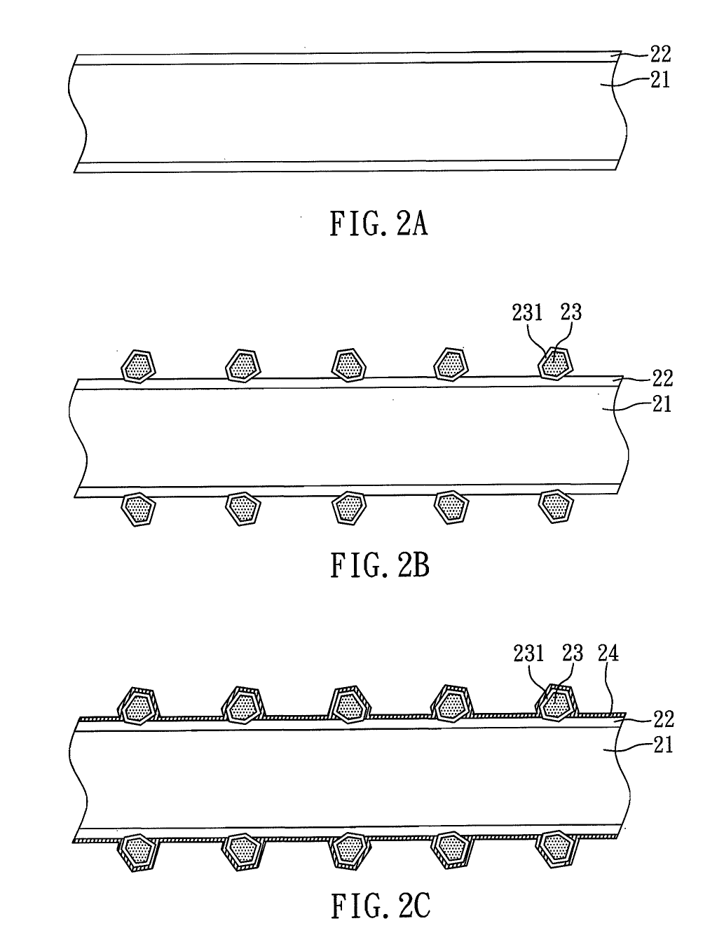

FIGS. 2A to 2C show a process for fabricating a wire saw according to the present example.

As shown in FIG. 2A, a core wire 21 is first provided, and an intermediate layer 22 is coated on the core wire 21. In the present example, the core wire 21 is a piano wire, and the intermediate layer 22 is a water layer. Subsequently, as shown in FIG. 2B, plural abrasives 23 are embedded into the intermediate layer 22. In the present example, the abrasives 23 are diamond particles coated with a conductive layer 231, and the conductive layer 231 is made of titanium.

Finally, as shown in FIG. 2C, a metal protective layer 24 (i.e. an electroplating layer) is formed by electroplating to cover the abrasives 23 and the intermediate layer 22. In the present example, the metal protective layer 24 is made of nickel.

According to the above-mentioned process, the present example provides a wire saw, as shown in FIG. 2G, which includes: a core wire 21; an intermediate layer 22, disposed over the core wire 21 and made of water; a plurality of abrasives 23, embedded in the intermediate layer 22; and a metal protective layer 24, covering the abrasives 23 and the intermediate layer 22.

### Example 2

The manufacturing process according to the present example is almost the same as that of Example 1, as shown in FIGS. 2A to 2C, except that the intermediate layer 22 of the present example is an electroplating solution layer, and the conductive layer 231 is made of nickel.

### Example 3

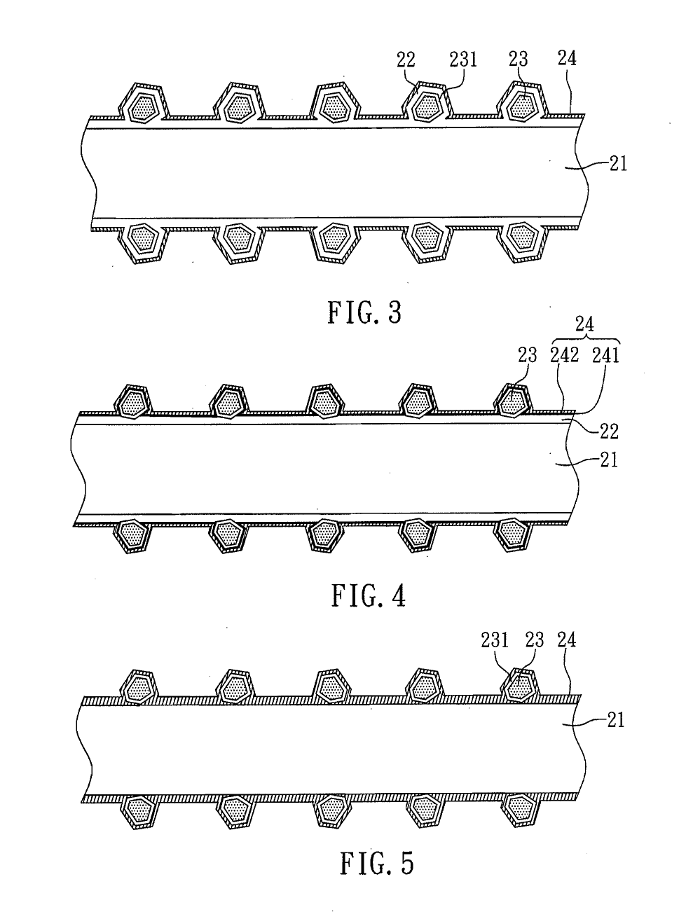

The manufacturing process according to the present example is almost the same as that of Example 1, as shown in FIG. 3, except that the intermediate layer 22 of the present example is formed on the core wire 21 by mixing a resin (as a component of the intermediate layer) with the abrasives 23 to form a mixture and then coating the mixture on the core wire 21. Accordingly, the abrasives 23 are embedded in and covered by the intermediate layer 22. In addition, the metal protective layer 24 of the present example is formed by a chemical plating process (i.e. an electroless plating process) and thus is called a chemical plating layer.

### Example 4

The manufacturing process according to the present example is almost the same as that of Example 1, as shown in FIG. 4, except that the intermediate layer 22 of the present example is an oil layer, and the metal protective layer 24 is formed by chemical plating a chemical plating layer 241 and then electroplating an electroplating layer 242 to cover the abrasives 23 and the intermediate layer 22. In the present example, the chemical plating layer 241 and the electroplating layer 242 are made of nickel. Accordingly, as shown in FIG. 4, the metal protective layer of the metal protective layer 24 includes a chemical plating layer 241 and an electroplating layer 242, therewith the chemical plating layer 241 being located between the electroplating layer 242 and the abrasives 23 and between the electroplating layer 242 and the intermediate layer 22.

### Example 5

The manufacturing process according to the present example is almost the same as that of Example 1, as shown in FIGS. 2A to 2B and 5, except that the intermediate layer 22 of the present invention is made of ethanol. Accordingly, the intermediate layer 22 of the present invention would gradually evaporate, and the abrasives 23 are adsorbed on the core wire 21 through van der Wall force. As shown in FIG. 5, the intermediate layer 22 disappears before the formation of the metal protective layer 24.

As above-mentioned, in the present invention, the abrasives are embedded into the intermediate layer, and the subsequent metal protective layer would cover the abrasives and the intermediate layer. Compared to the conventional art of simultaneously depositing the abrasives and the plating metal layer, it is unnecessary for the present invention to control the dispersion and concentration of the abrasives in the plating bath, and the aggregation of the abrasives in the plating bath during the plating process can be inhibited. Thereby, the present invention can fabricate a wire saw with a better surface flatness and thus enhance cutting quality and precision. In addition, the present invention uses a metal protective layer to cover and firmly hold the abrasives, and thus can extend the lifetime of the wire saw and enhance the processing efficiency. Also, the metal protective layer over the abrasives can provide buffer and protection effects, resulting in the enhancement of cutting quality.

The above examples are intended for illustrating the embodiments of the subject invention and the technical features thereof, but not for restricting the scope of protection of the subject invention. The scope of the subject invention is based on the claims as appended.

What is claimed is:

1. A method for fabricating a wire saw, comprising:
(A) providing a core wire;
(B) coating an intermediate layer over the core wire, and embedding a plurality of abrasives in the intermediate layer; and
(C) plating a metal protective layer over the abrasives.

2. The method as claimed in claim 1, wherein the intermediate layer is made of one selected form the group consisting of an adhesive material, a solvent, a solution and a combination thereof.

3. The method as claimed in claim 2, wherein the adhesive material is resin, the solvent is water, oil, ethanol, acetone, methanol or a combination thereof, and the solution is a plating solution.

4. The method as claimed in claim 1, wherein the step (B) is performed by coating the intermediate layer over the core wire and then embedding the abrasives in the intermediate layer.

5. The method as claimed in claim 1, wherein the step (B) is performed by mixing a component of the intermediate layer with the abrasives to form a mixture and then coating the mixture over the core wire.

6. The method as claimed in claim 1, wherein the core wire is a piano wire, a copper-coated piano wire, a twisted wire and a stainless steel wire.

7. The method as claimed in claim 1, wherein the abrasives are made of diamond, cubic boron nitride, aluminum oxide and silicon carbide.

8. The method as claimed in claim 1, wherein the abrasive are covered with a conductive layer.

9. The method as claimed in claim 1, wherein the conductive layer is made of titanium, nickel, copper, silver, aluminum or a combination thereof.

10. The method as claimed in claim 1, wherein the metal protective layer is made of nickel, copper, zinc, tin, silver or a combination thereof.

11. The method as claimed in claim 1, wherein the metal protective layer is formed by an electroplating process or a chemical plating process.

12. The method as claimed in claim 1, wherein the metal protective layer is formed by a chemical plating process and then an electroplating process.

13. A wire saw, comprising:
a core wire;
an intermediate layer, disposed over the core wire and made of an adhesive material, a solvent, a solution or a combination thereof;
a plurality of abrasives, embedded in the intermediate layer; and
a metal protective layer, covering the abrasives and the intermediate layer.

14. The wire saw as claimed in claim 13, wherein the adhesive material is resin, the solvent is water, oil or a combination thereof, and the solution is a plating solution.

15. The wire saw as claimed in claim 13, wherein the core wire is a piano wire, a copper-coated piano wire, a twisted wire and a stainless steel wire.

16. The wire saw as claimed in claim 13, wherein the abrasives are made of diamond, cubic boron nitride, aluminum oxide and silicon carbide.

17. The wire saw as claimed in claim 13, wherein the abrasive are covered with a conductive layer.

18. The wire saw as claimed in claim 17, wherein the conductive layer is made of titanium, nickel, copper, silver, aluminum or a combination thereof.

19. The method as claimed in claim 13, wherein the metal protective layer is made of nickel, copper, zinc, tin, silver or a combination thereof.

20. The method as claimed in claim 13, wherein the metal protective layer is an electroplating layer or a chemical plating layer.

21. The method as claimed in claim 13, wherein the metal protective layer comprises a chemical plating layer and an electroplating layer, and the chemical plating is located between the electroplating layer and the abrasives and between the electroplating layer and the intermediate layer.
